(19) United States
(12) Patent Application Publication
(10) Pub. No.: US 2024/0151334 A1
(43) Pub. Date: May 9, 2024

(54) SEAL ASSEMBLY AND JOINT BUSHING

(71) Applicant: Swiss Tech Innovation AG, Olten (CH)

(72) Inventor: Theodor WÜST, Wetzikon (CH)

(73) Assignee: Swiss Tech Innovation AG, Olten (CH)

(21) Appl. No.: 18/260,534

(22) PCT Filed: Dec. 23, 2021
(86) PCT No.: PCT/EP2021/087488

§ 371 Date: Jul. 6, 2023

(30) Foreign Application Priority Data
Jan. 6, 2021 (CH) 00007/21

(51) Int. Cl. F16L 21/04

(52) U.S. Cl. CPC F16L 21/04

(57) ABSTRACT

Disclosed is a sealing arrangement (10) for producing a sealing function in an, in particular static, pipe connection, in particular between a fluid-carrying pipe (11) and a connection sleeve (12). The sealing arrangement (10) comprises a ring seal (20) arranged in a circumferential groove (121), a seal seat (30) and a clamping element (40) for clamping the ring seal (20). The sealing arrangement (10) has a pressure side. The seal seat (30) is arranged in the circumferential groove (121) on the pressure side and has overflow openings (31) so that the ring seal (20) is exposed to the pressure of the fluid on the pressure side. Additionally or alternatively the seal seat (30) is arranged in the circumferential groove (121) and is configured to be conically tapering in the direction of the pressure side so that by clamping the ring seal (20) this is compressed in a radial direction, wherein the circumferential groove (121) remains accessible on the pressure side.

The present invention relates to a sealing arrangement for producing a sealing function in an, in particular static, pipe connection as well as a connection sleeve comprising a sealing arrangement according to the preamble of the independent claims.

Plug-in sleeves are frequently used for the connection of pipelines, in particular plastic pipelines, in which the end sections of the pipelines to be connected are introduced from two opposite sides and then fixed sealingly therein. Alternatively the plug-in sleeves can also be formed at the end of a pipeline.

In a widely used type of such plug-in sleeves the fixing is accomplished by means of ring seals of elastomeric material which at the same time ensure the necessary seal of the connection. The ring seals are located in circumferential annular grooves of the plug-in sleeve and when the end sections of the pipeline or pipelines to be connected are squeezed radially between an inner wall of the annular groove and an outer surface of the respective end sections so that they abut sealingly against the outer surfaces of the end sections and hold the end sections of the pipelines in a frictional connection.

The making of such connections using plug-in sleeves requires a relatively high expenditure of force in order to introduce the end sections of the pipelines to be connected into the plug-in sleeve since the necessary strong squeezing of the ring seals of the introduction of the end sections encounters a considerable resistance. In addition, there is the risk that the corresponding ring seal becomes damaged when slipping over the end section of the pipe. In order to avoid this, the respective end sections must be additionally machined, for example, deburred.

EP 3 120 064 B1 discloses a plug-in connection with a ring seal which eliminates at least one of these disadvantages. EP 3 120 064 B1 discloses a plug-in connection with a ring seal which is deformed by means of a clamping element. As a result of the clamping of the clamping element which is configured as a toggle lever, a width of an annular groove in which the ring seal is inserted is reduced so that the ring seal is squeezed on both sides. The ring seal rests with an external circumference in the base of the ring groove so that due to the deformation an internal diameter of the ring seal is reduced and this comes to abut with the pipe to be connected. With this arrangement a pipe end can be tightly connected with a corresponding plug-in connection. However, such a connection is not very suitable for connecting pressurized pipes since the ring seal is exposed to an internal pressure of the pipe precisely in the region of its contact with the pipe end and as a result tends to lift.

It is therefore an object of the invention to eliminate at least one or more disadvantages of the prior art. In particular, a sealing arrangement and a connection sleeve should be provided which makes it possible to use all the essential constructive properties of a ring seal. Preferably an additional machining step for deburring a pipe end should be prevented or at least the expenditure for deburring should be reduced.

This object is achieved by the devices defined in the independent claims. Further embodiments are obtained from the dependent claims.

A sealing arrangement according to the invention for producing a sealing function in an, in particular static, pipe connection, in particular between a fluid-carrying pipe and a connection sleeve comprises a ring seal arranged in a circumferential groove. The sealing arrangement comprises a seal seat and a clamping element for clamping the ring seal, wherein as a result of the clamping of the ring seal this can be brought or is brought to abut with the fluid-carrying pipe. This also enables a ring seal to be used which has an internal diameter greater than an external diameter of the pipe end to be sealed. Accordingly the ring seal need not be inverted or pulled over an edge of the pipe end but as a result of its larger diameter, can be slid over the pipe end without interference with this. The sealing arrangement has a pressure side.

The pressure side of the sealing arrangement is that side that is exposed to pressure from the pipe to be connected in the operating state.

The seal seat is arranged in the circumferential groove on the pressure side and has overflow openings so that the ring seal is exposed to the pressure of the fluid on the pressure side.

Additionally or alternatively the seal seat can be arranged in the circumferential groove in such a manner that it is configured to be conically tapering in the direction of the pressure side so that by clamping the ring seal this is compressed in a radial direction, in particular displaced, wherein the circumferential groove remains accessible on the pressure side.

That means in other words that the circumferential groove can be exposed to a pressure on its pressure side, in particular on the base of the groove.

Directional designations are defined in the present case by the sealing arrangement in generic use. An axial direction thus substantially corresponds to the direction of the longitudinal axis of a pipe to be connected and accordingly a radial corresponds to the direction of a beam extending at right angles from this axis. A compression in the radial direction therefore corresponds to a displacement of an element or a surface in the direction of the longitudinal axis of the pipe.

Since the circumferential groove is accessible on the pressure side and accordingly can be exposed to pressure, the ring seal can also be exposed to pressure. An existing pressing on the ring seal is additionally intensified by this pressure application. In other words, with the increase of the pressure inside the pipe connection, the pressure on the ring seal is increased and thus the sealing function is increased accordingly.

In this case, it can be provided that the overflow openings are configured as radially extending grooves. This on the one hand allows a simple and cost-effective manufacture, on the other hand, for example, a visual inspection of the state of the overflow openings before or during the installation is easily possible.

Alternatively the overflow openings can be configured as radially extending bores. As a result of the configuration as bores, the seal seat can be provided with a circumferential and uninterrupted surface and thus provide a correspondingly large contact surface for the ring seal.

A combination of these two embodiments is also possible.

The seal seat can have a contact surface for contact of the ring seal. Preferably this contact surface is spaced apart from a base of the circumferential groove by a recess. In this case, it can be provided in particular that the recess is configured as a radially inwardly offset surface of the seal seat.

Such a configuration of the seal seat with a recess ensures that the ring seal can also be exposed to pressure in the region of its greatest diameter, in particular in the region of the base of the groove. In other words, as a result of such a configuration substantially the entire surface of the ring seal arranged on the pressure side of the seal arrangement can be uniformly exposed to pressure.

The seal seat is preferably configured to be annular. Thus, it can easily be manufactured with a high accuracy.

In the case in which the seal seat is configured to be conically tapering in the direction of the pressure side, this can be configured to be conically tapering with an angle of 5° to 20°, in particular of 7° to 15°, preferably at an angle of 7° to 12° in particular at an angle of 10°.

This minimum angle and maximum angle ensure that a corresponding reduction of an internal diameter of the ring seal takes place but this is not forced rapidly in such a manner that the ring seal suffers damage. It can be seen that the flatter the angle is, the more the clamping element must be moved in order to achieve a corresponding desired narrowing of the internal diameter. An angle of 10° has proved to be particularly advantageous here.

The seal seat can be fabricated from plastic. This allows easy and cheap manufacture.

The seal seat is preferably configured as a separate element, alternatively however this can be configured as an integral component of the connection sleeve. Integral manufacture is particularly advantageous if the seal seat is configured to be conically tapering.

The ring seal can be configured as an O-ring. O-rings are easy to manufacture, favourable and available in different standard sizes. In addition, they can be changed easily and have extremely homogeneous properties.

As has already been set out, the ring seal can have a diameter that is greater than an external diameter of the pipe to be sealed. This enables the sealing arrangement to be joined without force onto a corresponding pipe end without the ring seal contacting the pipe end.

In this case, it can be provided in particular that an internal diameter of the ring seal is greater than an internal diameter of the groove. The internal diameter of the groove is defined by the surfaces adjacent to the groove.

In other words, the ring seal is set back with respect to the elements adjoining the ring seal and therefore protected.

Preferably the clamping element is arranged axially movably and can thus be displaced in the axial direction, i.e. along the pipe. This enables the width of the circumferential groove to be varied simply so that the ring seal can be easily clamped.

Preferably the circumferential seal is delimited on one side by the clamping element. In other words, the circumferential groove has a fixed and a movable side wall wherein the movable side wall is configured as part of the clamping element. The clamping of the ring seal can thus be accomplished easily.

A further aspect of the invention relates to a connection sleeve comprising a sealing arrangement as described in the present case.

This makes it possible to provide a compact unit for connecting pipe ends.

In this case, the clamping element can be configured as a sleeve that can be screwed into the connection sleeve.

The ring seal can be pre-tensioned by simply twisting or screwing the clamping element into the connection sleeve.

Alternatively the clamping element can be configured as an end section of an arrangement of a plurality of clamping members, which can be moved into a stable position via a dead point.

As a result, the ring seal can be exactly pre-tensioned by simply snapping over the clamping elements. The clamping members can be configured in particular as described in EP 3 120 064 B1.

Alternatively the clamping element can be configured as a clamping ring with clamping screws, wherein the clamping ring can be displaced in the direction of the ring seal by means of the clamping screws.

This in particular makes it possible to provide relatively large connection sleeves and bring about relatively high pre-tensioning forces.

The connection can be configured in such a manner as described in the present case that this has a second sealing arrangement as described in the present case which in particular is arranged opposite the first sealing arrangement.

With such a connection sleeve two pipe ends can be connected to one another easily and securely. The two pipe ends can preferably be inserted from the opposite direction into the connection sleeve and clamped and sealed with the corresponding sealing arrangement in each case.

Several possible embodiments of the sealing arrangement are explained with reference to the schematic figures. In the figures:

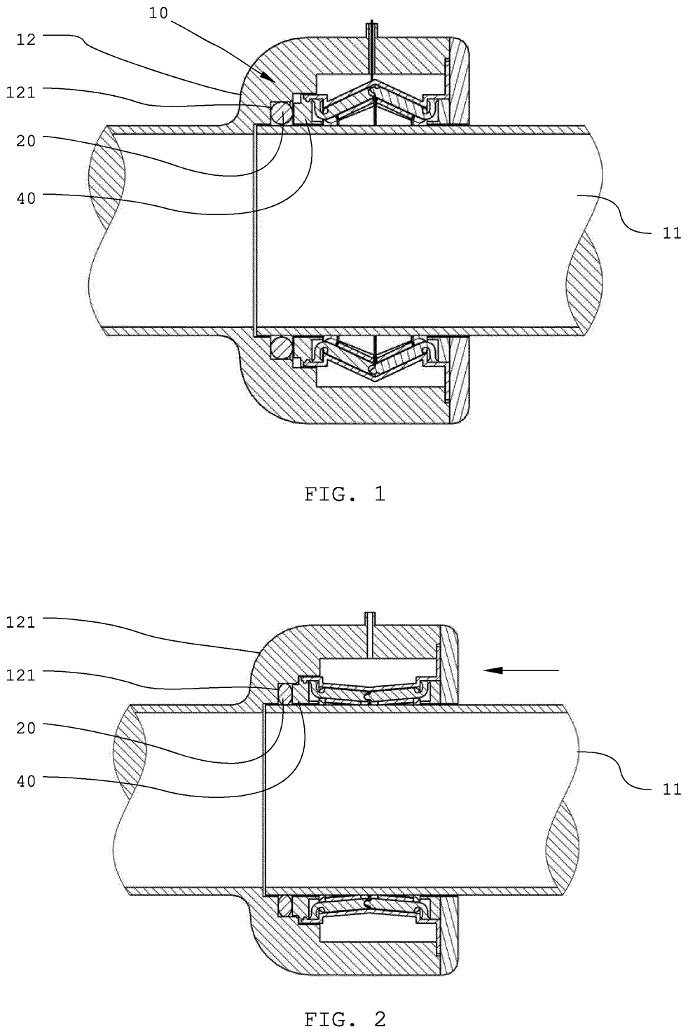

FIG. 1: shows a connection sleeve from the prior art in the open position;

FIG. 2: shows the connection sleeve according to FIG. 1 in the clamped position;

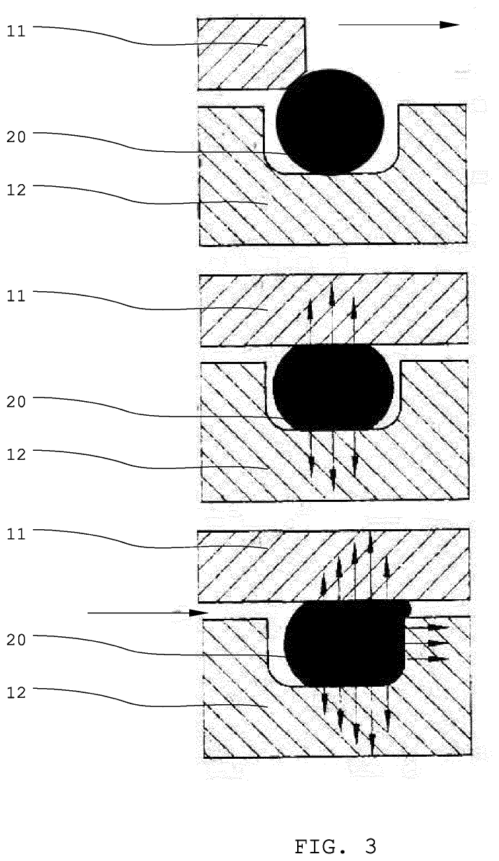

FIG. 3: shows the functional principle of a conventional O ring;

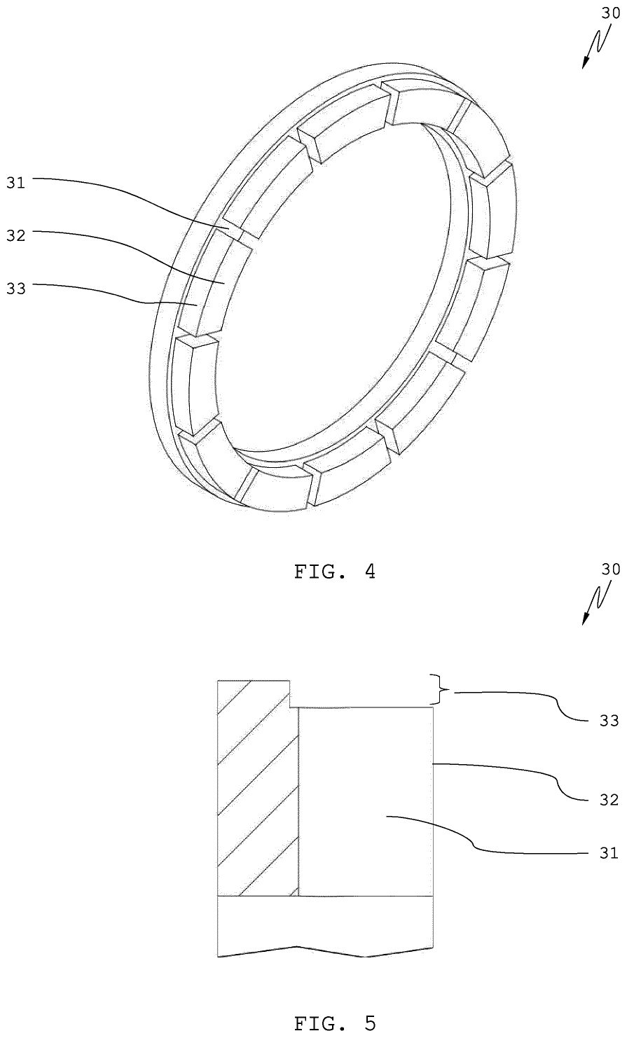

FIG. 4: shows a first embodiment of a seal seat;

FIG. 5: shows a detailed view of a cross-section through the seal seat according to FIG. 4;

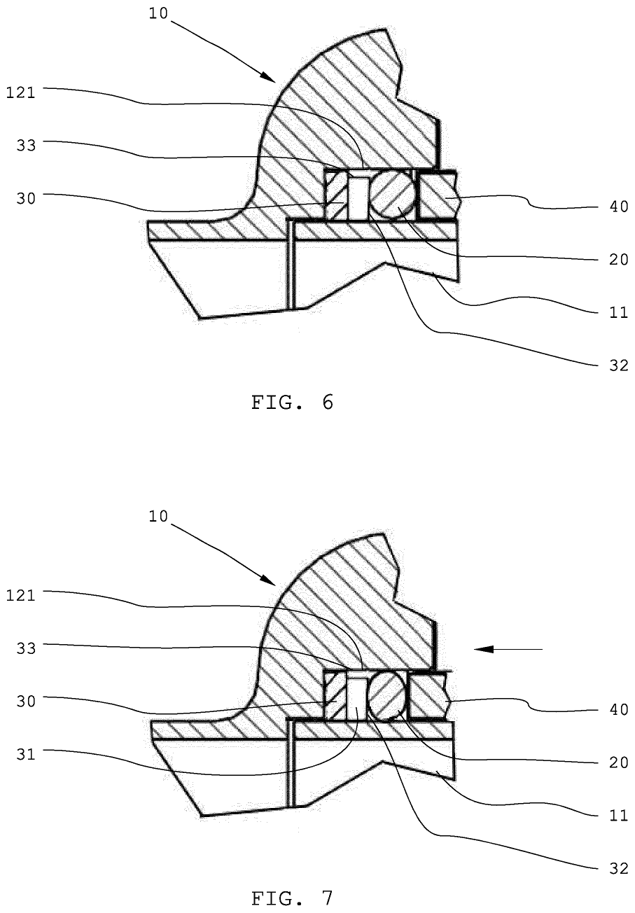

FIG. 6: shows a detailed view of a cross-section of a sealing arrangement in the installed state in the open position;

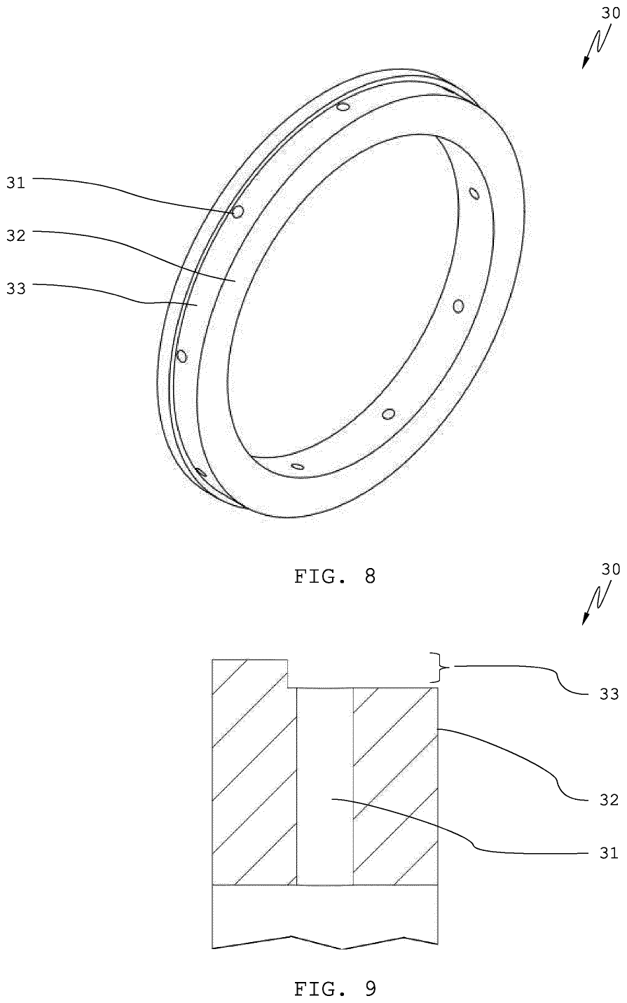

FIG. 7: shows the detailed view according to FIG. 6 in the clamped position;

FIG. 8: shows a second embodiment of a seal seat;

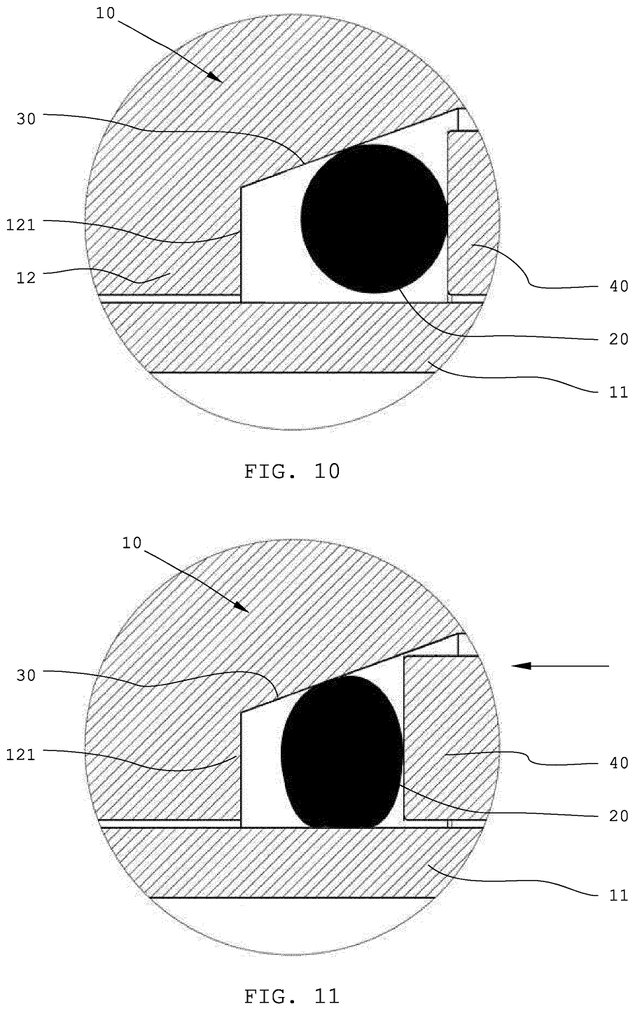

FIG. 9: shows a detailed view of a cross-section through the seal seat according to FIG. 8;

FIG. 10: shows a detailed view of a cross-section of a sealing arrangement in the installed state in the open position;

FIG. 11: shows the detailed view according to FIG. 10 in the clamped position;

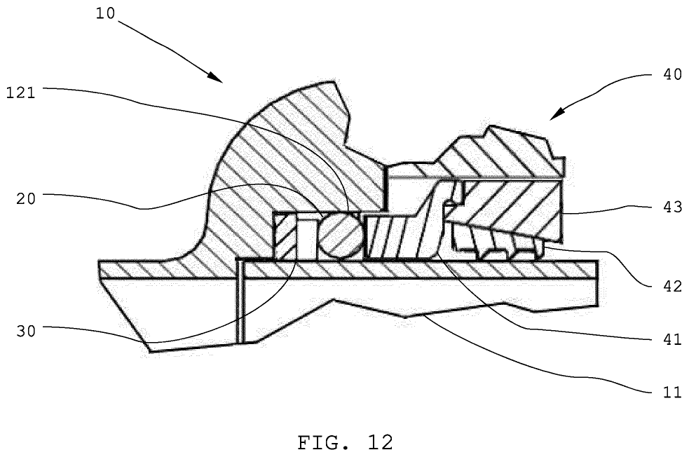

FIG. 12: shows a sealing arrangement with an alternative configuration of a clamping element.

FIG. 1 shows a connection sleeve 12 from the prior art in the open position. A sealing arrangement 10 is arranged in the connection sleeve 12. The sealing arrangement 10 comprises a ring seal 20 which is configured as an O ring in the present case.

The sealing arrangement 10 additionally has a clamping element 40. The clamping element 40 is movable axially and displaceable with clamping members not designated in detail which are configured as toggle levers. The clamping element 40 is an integral part of the arrangement of clamping members in the present case as an end section. The ring seal 20 is arranged in a circumferential groove 121 in the connection sleeve 12. The fundamental structure of the connection sleeve 12 corresponds to the structure disclosed in EP 3 120 064 B1. Likewise, the structure, the arrangements and the operating mode of the clamping members corresponds to that from EP 3 120 064 B1.

FIG. 2 shows the connection sleeve 12 according to FIG. 1 in the clamped position. The ring seal 20 was compressed due to the radial impressing of the toggle levers which hold the clamping element 40. Its shape has therefore changed from a substantially round shape (see on this matter FIG. 1) into a substantially oval shape. The ring seal 20 lies on the base of the circumferential groove 121, on the side walls of the groove 121, wherein one of these side walls is formed by the clamping element 40 and on an outer surface of the pipe end of the pipe 11. The ring seal 20 thus has contact on four sides with a counter-piece. Only one region of the ring seal 20 in the region of its contact with the pipe 11 is accessible from inside the pipe and can be exposed to pressure. The application of pressure at this point has the result that the ring seal 20 is pressed on and releases its contact with the pipe 11 and the connection sleeve 12 thus becomes non-tight.

FIG. 3 shows the functional principle of a ring seal 20 which is configured as a conventional O ring. The O ring lies in a groove not designated in detail of a connection sleeve 12. A pipe 11 to be sealed is pressed into the connection sleeve 12 in the direction of the arrow. As can easily be seen, in the region of first contact with the O ring the pipe 11 must have a bevel to avoid the O ring being damaged. During the sliding-on process (transition from the first to the middle diagram), the ring is radially compressed. This then applies a certain pressing force onto the base of the groove and onto the outer wall of the pipe 11. The third diagram according to FIG. 3 now shows the situation when an interior of the pipe 11 is pressurised. The O ring is accordingly pressed onto a side wall of the circumferential groove facing away from the pressure side. In addition, the pressure of the O ring in the radial direction and opposite the radial direction increases. In other words, the contact pressure of the O ring in the circumferential groove and on the outer side of a pipe 11 increases with increasing pressure which acts on the pressure side on the O ring.

It is immediately apparent that with a connection sleeve according to the prior art (FIGS. 1 and 2), a one-sided application of pressure to the O ring is not possible since this is compressed laterally in order to achieve a radial pre-tension as shown in the middle diagram of FIG. 3.

FIG. 4 shows a first embodiment of a seal seat 30. The seal seat 30 is configured to be substantially annular and has a plurality of overflow openings. For better clarity only one of the overflow openings 31 is provided with a reference number. The seal seat 30 additionally has a contact surface 32 for contact of a seal ring. As can be seen from FIG. 4, this contact surface is divided into several section by the overflow openings 31. The overflow openings 31 are configured as radially extending grooves in the present case. A recess 33 is arranged on the periphery of the seal seat 30 so that the contact surface 32 is spaced apart from a circumferential groove in which the seal seat 30 is arranged or can be arranged. Through the overflow openings 31 a connection is made from a region of the circumferential groove directed towards the centre of a pipe to a region on the base of the groove so that a pressure compensation can be created by these overflow openings 31 or the recess 33 can be exposed to pressure.

FIG. 5 shows a detailed view of a cross-section through the seal seat 30 according to FIG. 4. The cross-section extends in the present case through one of the overflow openings 31. Due to the recess 33 the contact surface 32 is set back in relation to an outermost edge of the seal seat 33 and thus spaced apart from a base of a circumferential groove in generic use.

FIG. 6 shows a detailed view of a cross-section of a sealing arrangement 10 in the installed state in the open position. The sealing arrangement 10 comprises a seal seat 30 as described for FIG. 4. The cross-section shown here corresponds to that of FIG. 5. The sealing arrangement 10 is shown in the open position in the present case. It can be seen that the ring seal 20 is slightly spaced apart from an outer surface of the pipe 11. The ring seal 20 however contacts the contact surface 32 of the seal seat 30 on one side and on the opposite side a surface of the clamping element 40. The ring seal 20 rests with its outer periphery on a base of the groove 121. In the position shown here the pipe 11 can be moved into the sealing arrangement 10 or removed from it without colliding with the ring seal 20.

FIG. 7 shows the detailed view according to FIG. 6 in the clamped position. The clamping element 40 was moved in the direction of the arrow in the direction towards the ring seal 20 so that the ring seal 20 was clamped between the seal seat 30 and the clamping element 40 and has been deformed accordingly. As a result of this deformation, an internal diameter of the ring seal 20 has decreased so that the ring seal 20 now rests with its inner periphery on an outer circumference of the pipe 11. As can be seen in FIG. 7, an annular space formed by the recess 33 in the groove 121 is accessible with a fluid. This can flow along the outer surface of the pipe 11 and flow into this recess 33 through the overflow openings 31 in the seal seat 30. The ring seal 20 can therefore be exposed to pressure both in the region of the seal or its contact with the pipe 11 and also in the region of its seal or its conect with the base of the groove 121. In other words, the ring seal 20 can be exposed to the pressure of a fluid located in the pipe 11 on its pressure side. As a result of this arrangement, an increase in the pressure in the radial direction and opposite the radial direction can be achieved through the ring seal 20. With increasing pressure the ring seal 20 is deformed in such a manner that this lifts from the contact surface 32.

FIG. 8 shows a second embodiment of a seal seat 30. The seal seat 30 is configured to be substantially annular and has a plurality of overflow openings 31. For better clarity only one of the overflow openings 31 is provided with a reference number. The seal seat 30 additionally has a contact surface 32 for contact of a ring seal. As can be seen from FIG. 4, this contact surface 32 is configured to be continuous. In the present case, the overflow openings 31 are configured as radially extending bores. Located on the periphery of the seal seat 30 is a recess 33 into which these bores open. The contact surface 32 is spaced apart from a circumferential groove in which the seal seat 30 is arranged. Through the overflow openings 31 a connection is made from a region of the circumferential groove directed towards the centre of a pipe to a region on the base of the groove so that a pressure equalization can be created via these overflow openings 31 or the recess 33 can be exposed to pressure.

FIG. 9 shows a detailed view of a cross-section through the seal seat 12 according to FIG. 8. The cross-section extends in the present case through one of the overflow openings 31. Due to the recess 33 the contact surface 32 is set back in relation to the outermost edge of the seal seat 33 and thus in generic use with respect to a base of a circumferential groove.

The embodiment of the seal seat according to FIGS. 8 and 9 is fully compatible with the sealing arrangement according to FIGS. 6 and 7 and with the seal seat 30 illustrated therein.

FIG. 10 shows a detailed view of a cross-section of an alternative sealing arrangement 10 in the installed state in the open position. In this sealing arrangement 10 the seal seat 30 is configured as an integral component of a circumferential groove 121 of a connection sleeve 12. The seal seat 30 is in the present case configured as a conically tapering surface in the direction of a pressure side. Here it can also be seen that the ring seal 20 has an internal diameter which is greater than an external diameter of a pipe 11. In the state shown here the ring seal 20 rests on the surface of the seal seat 30 and also on a surface of the clamping element 40.

FIG. 11 shows the detailed view according to FIG. 10 in the clamped position. The clamping element 40 was actuated and moved in the axial direction, illustrated by an arrow. Accordingly, the ring seal 20 was moved along the conically tapering surface of the seal seat 30 in the direction of the pressure side of the pipe connection. As can be seen, the ring seal 20 was deformed and displaced radially and/or compressed in the direction of the centre of the pipe. It can be seen that the ring seal is now in contact with an outer surface of the pipe 11, with the surface of the seal seat 30 and with the clamping element 40. It is immediately apparent that the pressure side of the ring seal can be completely exposed to pressure and a state such as has been described for the third diagram from FIG. 3 occurs at this ring seal 20. Due to the application of pressure, on the one hand therefore the seal of the pipe 11 is increased and on the other hand, also the clamping of the pipe by the ring seal 20.

FIG. 12 shows a sealing arrangement 10 with an alternative configuration of the clamping element 40. This design is compatible with all the designs described and the function of the ring seal 20 and the seal seat 30 corresponds to those from the previously described exemplary embodiments which is why a renewed repetition is dispensed with. In other words, the clamping element 40 can be configured as described previously for example as an end section of an arrangement of toggle levers which is moved axially by the clamping of the toggle levers.

The clamping element 40 has a multipart structure and comprises a pressure ring 41, a clamping ring 42 and a cone ring 43. The pressure rung 41 can be brought to abut with the ring seal 20 and with the cone ring 43. A clamping ring 42 is arranged centrally inside the cone ring 43. The cone ring 43 and the clamping ring 42 are mounted displaceably with respect to one another on conical surfaces. The cone on the cone ring 43 widens in the direction of the joining direction so that due to a movement of the cone ring 43 in the direction of the ring seal 20 the clamping ring 42 is radially compressed. As a result of this radial pressure, the clamping ring 42 is pressed onto the pipe 11 so that this is held by an additional radial force.

As a result of the movement of the cone ring 43 in the direction of the ring seal 20, this presses onto the seal ring 41 which again moves in the direction of the ring seal 20 and deforms this as described in the present case.

The clamping ring 42 has prongs on its inner circumference which are directed contrary to the joining direction of the pipe 11. During a movement of the pipe 11 contrary to the joining direction the clamping ring 42 is again pressed further into the cone and the radial force holding the pipe 11 is additionally increased.

1-17. (canceled)

18. A sealing arrangement (10) for producing a sealing function in a static pipe connection between a fluid-carrying pipe (11) and a connection sleeve (12), comprising a ring seal (20) arranged in a circumferential groove (121), a seal seat (30) and a clamping element (40) for clamping the ring seal (20), wherein the sealing arrangement (10) has a pressure side, wherein the seal seat (30) is arranged in the circumferential groove (121) on the pressure side and has overflow openings (31) so that the ring seal (20) is exposed to the pressure of the fluid on the pressure side.

19. The sealing arrangement (10) according to claim 18, wherein the overflow openings (31) are configured as radially extending grooves.

20. The sealing arrangement (10) according to claim 18, wherein the overflow openings (31) are configured as radially extending bores.

21. The sealing arrangement (10) according to claim 18, wherein the seal seat (30) has a contact surface (32) for contact of the ring seal (20) and the contact surface (32) is spaced apart from a recess (33) by a base of the circumferential groove (121).

22. The sealing arrangement (10) according to claim 18, wherein the seal seat (30) is configured to be annular.

23. The sealing arrangement (10) according to claim 18, wherein the seal seat is configured to be conically tapering with an angle of 5° to 20°, in particular of 7° to 15°, preferably at an angle of 7° to 12°, in particular at an angle of 10°.

24. The sealing arrangement (10) according to claim 18, wherein the seal seat (30) is fabricated from plastic.

25. The sealing arrangement (10) according to claim 18, wherein the seal seat (30) is configured as an integral component of the connection sleeve (12).

26. The sealing arrangement (10) according to claim 18, wherein the ring seal (20) is configured as an O ring.

27. The sealing arrangement (10) according to claim 18, wherein the ring seal (20) has an internal diameter that is greater than an external diameter of the fluid-carrying pipe to be sealed.

28. The sealing arrangement (10) according to claim 18, wherein the clamping element (40) is arranged to be axially movable.

29. The sealing arrangement (10) according to claim 18, wherein the circumferential groove (121) is delimited on one side by the clamping element (40).

30. A connection sleeve (12) comprising a sealing arrangement (10) according to claim 18.

31. The connection sleeve (12) according to claim 30, wherein the clamping element (40) is configured as sleeve that is screwable into the connection sleeve (12).

32. The connection sleeve (12) according to claim 30, wherein the clamping element (40) is configured as an arrangement of a plurality of clamping members which are movable into a stable position via a dead point.

33. The connection sleeve (12) according to claim 30, wherein the clamping element (40) is configured as a clamping ring with clamping screws, wherein the clamping ring is displaceable in a direction of the ring seal (20) by means of the clamping screws.

34. The connection sleeve (12) according to claim 30, wherein the connection sleeve has a second sealing arrangement (10) which is arranged opposite the sealing arrangement (20).
